(19) United States
(12) Patent Application Publication
(10) Pub. No.: US 2003/0230117 A1
(43) Pub. Date: Dec. 18, 2003

(54) Apparatus for refining a glass melt

(76) Inventors: Klaus Jochem, Essenheim (DE); Franz Ott, Mitterteich (DE)

Correspondence Address: STRIKER, STRIKER & STENBY, 103 East Neck Road, Huntington, NY, 11743, US

(21) Appl. No.: 10/454,657

(22) Filed: Jun. 4, 2003

(30) Foreign Application Priority Data
Jun. 7, 2002 (DE) 102 25 280.7

(51) Int. Cl. C03B 5/225

(52) U.S. Cl. 65/346; 65/347

(57) ABSTRACT

The apparatus for refining a glass melt has a refining unit, which includes a horizontally extending refining section for removal of rising gas bubbles from the glass melt flowing through the refining section. So that the refining section can be shortened in contrast to a refining section in an apparatus with an open channel flow, the refining section according to the invention is formed so that the glass melt flow rate is higher over a substantial lengthwise portion of it near its bottom and lower near a surface of the glass melt flowing through it in comparison to the corresponding flow rates in an open channel flow for the same throughput. The refining section is advantageously at least partially covered with a fire resistant cover, which contacts the glass melt flowing through it and has at least one opening through which gas bubbles can escape. In addition the refining section may be provided with built-in elements shaped to provide the desired improved flow rate profile for the glass melt.

### BACKGROUND OF THE INVENTION

The present invention relates to an apparatus for refining a glass melt comprising a refining unit that has at least one horizontally extending refining section for removal of rising gas bubbles from the glass melt flowing through the refining section.

Considerable amounts of gases are produced in glass melts as a result of chemical reaction of the mixture of staring materials. According to a gross estimate about 1 kg of glass is produced from 1.2 kg of the starting mixture, i.e. during the melting ⅕ of the mixture weight is released in the form of gas. Other gases are physically carried along with the mixture or introduced by the combustion heat source into the glass melt.

Most gas escapes of course during the initial melting of the glass, however a considerable fraction of the gas is captured in the melt. One part of the captured gas is dissolved in the glass melt. Another part remains in the melt as localized gas inclusions, so-called bubbles. When the bubble interior pressure is higher or lower than the equilibrium pressure of the dissolved gases, the bubbles grow or shrink respectively. The gas bubbles have different sizes because of that.

Since the glass bubbles disadvantageously impair the quality of the glass or glass ceramic body, which is made from the glass melt, the glass melt must be refined or purified of the gas.

The term “refining of glass” means a melt-processing step following the primary melting process in a so-called refining region.

Various methods are set up in known ways for refining.

The gas bubbles have the tendency to rise in the melt and then escape into the atmosphere because of their static buoyancy due to density differences between the gas bubbles and the glass melt. However this process consumes considerable time without other influences, which make the production process very expensive because of the required longer processing time. Thus it is known to produce higher temperatures in the refining zone in order to reduce the viscosity of the glass melt and thus increase the rising speed of the gas bubbles. Of course this additional temperature increase requires considerable added energy, which puts a considerable added cost burden on the production process. Furthermore there is a danger of evaporation of ingredients from the glass melt at the higher temperatures, which is disadvantageous. This can have different undesirable and disadvantageous consequences.

Increasing the bubble diameter is an additional possibility for increasing the rising speed of the gas bubbles. The usual temperature increase during refining however does not lead to any noteworthy increase in bubble diameter by itself. The method of chemical refining of glass with oxides having temperature dependent oxidation states is a proven and largely optimized method of refining the glass melt. Particularly the refining agents Sb(V) oxide, As(V) oxide and Sn(IV) oxide are used in this latter method. The chemical refining method releases gases in the glass melt, which enter the gas bubbles due to transport processes. These gas quantities arriving in the gas bubbles lead to desirable bubble growth.

Also so-called physical refining methods are also known, which leave the chemical composition of the glass largely undisturbed or not damaged. Physical refining of the glass melt is based on “forcing” the bubbles to rise to the surface of the melt with physical methods. The bubbles then burst there and release their gas content or dissolve in the melt.

The so-called low pressure refining, which is described in numerous prior art references, is a widely used physical refining process. This process is described, for example, in EP 0 908 417.

In low pressure refining the bubbles present in the melt grow. The bubble growth depends on the Boyle-Marriotte law, “p·V=const.”. I.e., if the pressure falls, the volume increases and, among other things, the partial pressures of the gases present in the bubbles is reduced below the partial pressure of the gases in the melt. Thus gases flow from the melt into the bubbles. The bubbles grow because of this effect, rise more rapidly to the surface of the melt and burst there or are “skimmed off” there. Also the tendency to form new bubbles spontaneously from the dissolved gases at so-called nuclei (walls, mini-bubbles) must be considered. Generally this latter process leads to foam, which can be combated with suitable methods.

Besides the methods, which accelerate the growth of the bubbles in order to increase the speed by which the bubbles rise to the surface of the glass melt, the flow guiding of the glass melt to be refined in suitable refining banks, such as described in EP 0 949 210 A1, and/or in horizontal refining sections, in the following designated refining units, is considered to be of great importance.

The flow of the glass melt is adjusted as much as possible so that similarly the rise of the gas bubbles is improved. In the known refining unit the rise of gas bubbles to the surface of the glass melt is improved by an only small height of the glass melt between the bottom of the refining unit and the surface of the glass melt in contrast to that of the glass melt or refining vessel.

There is an essentially open channel flow in the refining section of the known refining units, i.e. in the refining bank and horizontal refining section of the low-pressure refining units. This type of flow is characterized by the glass melt adhering to the lateral walls and bottom of the refining section. Starting from the sidewalls and bottom of the refining section the flow rate increases as one moves to the center of the refining unit and to the surface of the glass melt.

FIGS. 5A and 5B show the known flow or flow rate profile in an open channel or conduit of a refining unit. FIG. 5A is a longitudinal sectional view through the open channel, while FIG. 5B is a top plan view of the open flow channel. Generally some additional convection flow also occurs. With the usual small glass bath height and the good heat insulation the convection flows are small in relation to the throughput and thus can be disregarded.

This known flow rate profile however is disadvantageous for removing the glass bubbles from the glass melt, since a comparatively large structural volume for the refining unit is required. The reason for that is that the part of the glass melt near the bottom is already bubble free in a comparatively short flow distance in the refining unit because of the rise of the gas bubbles. The part of the glass melt near the bottom however flows comparatively slowly to the outlet of the refining unit. The part of the glass melt near the surface flows comparatively rapidly to the outlet. It is also fed with rising gas bubbles from the part of the glass melt below it. The size or dimensions of the refining unit, i.e. the length of the refining section, is thus determined by the flow rate of the part of the glass melt near the surface.

### SUMMARY OF THE INVENTION

It is an object of the present invention to provide an apparatus for refining a glass melt of the above-described kind, in which the flow rate profile is adjusted so that the glass melt is bubble free in a comparatively shorter refining section than in the refining sections according to the prior art. That means all the glass bubbles with diameters greater than or equal to a critical diameter are removed in the apparatus according to the invention. Gas bubbles with diameters smaller than the critical diameter can be present in the glass melt. If no gas bubbles greater than or equal to the critical diameter are present in the glass melt, the glass melt is characterized as bubble free.

This object, and others which will be made more apparent hereinafter, is attained in an apparatus for refining a glass melt comprising a refining unit, which has at least one horizontally extending refining section for removal of rising gas bubbles from the glass melt flowing in the refining section.

According to the invention the refining section is formed so that a glass melt flow rate near a bottom of the glass melt is higher over a substantial lengthwise portion of the refining section in comparison to a corresponding glass melt flow rate near the bottom in an open channel flow for equal throughput and/or so that a glass melt flow rate near a glass melt surface is lower in comparison to a corresponding glass melt flow rate near the surface of the glass melt in an open channel flow for equal throughput.

In preferred embodiments of the refining apparatus it is especially advantageous when the horizontally extending refining section is formed so that glass melt flow rates distributed over a horizontal plane extending across the horizontally extending refining section vary less than in an open channel flow for equal throughput.

By changing the flow rate profile of the glass melt in the refining unit in comparison to the flow rate profile in open channel flow an improved separation of the glass bubbles along a shorter lengthwise refining section is obtained. This means that a smaller structure volume is possible for the refining unit. This is a substantial advantage in comparison to the current embodiment with the open channel flow.

An additional advantage is that in existing refining units an efficiency increase, e.g. higher throughput, is possible by following or added changes.

An optimum flow rate profile is then achieved in refining units according to the invention, when, on the one hand, the part of the glass melt made bubble free by the rising of the gas bubbles arrives with the greatest possible flow rate at the outlet of the refining unit and, on the other hand, the part that is still not bubble free in contrast flows with as low as possible a flow rate to the outlet.

Built-in units for the refining section are known, which are immersed in the region of the glass melt near the surface and thus influence the flow rate. All these known built-in units have in common that they influence only the flow only locally. In contrast in the case of the present invention the flow is influenced along a substantial lengthwise portion of the refining section. Only in that way can the flow rate profile of the prior art shown in FIGS. 5A and 5B be changed in the sense of the invention.

Thus EP 0 908 417 A2 shows a horizontal refining bank, in which barriers are immersed in the melt bath in order to block rising gas bubbles. These barriers serve as foam barriers and extend transverse to the flow direction of the glass melt. They produce local changes in the flow conditions, however they do not correspond to the invention disclosed here.

Furthermore U.S. Pat. No. 5,433,765 A and PAJ abstract for JP 06 321 547 A disclose a refining unit with a glass melt flowing in it with a stirrer as built-in unit, which reaches from the glass bath surface to near the bottom of the unit. If the stirrer is not in operation, it influences the flow only locally and not along a substantial lengthwise portion of the glass melt flow path. Since the stirrer reaches nearly to the bottom, the flow rates are not comparatively lower in the vicinity of the glass bath surface.

The flow rate profile claimed according to the invention can not be obtained by using this sort of stirrer.

In operation the stirrer provides a thorough mixing/homogenizing of the glass melt. That means also that gas bubbles in the unit are mixed thoroughly with the glass melt. In contrast, the purpose of the claimed built-in unit in the case of the present invention is the separation of the gas bubbles from the glass melt.

AT 23 00 33 discloses a unit with a glass melt that has a floating body for influencing the glass flow. The flowing body, also called a dam body, is arranged like a dam nearly perpendicular to the main flow direction. In this way the floating body influences the flow rate profile in the flow direction in the unit only locally and not along a substantial lengthwise or longitudinal portion in the direction of the flow. That is insufficient to obtain any noteworthy additional separating action to separate the gas bubbles from the glass.

DE 27 43 289 A1 discloses a homogenizing apparatus for a glass melt with two stirrer sections and an intervening built-in element comprising plates in a fore-hearth or settler. The lower edges of the plates are in contact with the bottom of the fore-hearth or settler and form a shear plane in cooperation with the bounding lateral walls of the fore-hearth or settler. The purpose of this built-in element is thus to provide a certain shear in the glass melt over the entire height from the bottom to the glass bath surface. A parabola-shaped flow rate profile is obtained in a horizontal plane extending between the plates. In a vertical plane between the plates and parallel to the plates the flow rate profile that has a parabolic dependence on the glass bath height, increasing from 0 m/s from the bottom of the unit (boundary condition). The maximum flow rate is reached at the glass bath surface, or already under it, according to the ratio of the spacing of the plates and the glass bath height. Then it remains constant in the upper region. The arrangement of the built-in unit for adjusting the claimed flow rate profile with a lesser flow rate in the vicinity of the glass bath surface than near the bottom according to the invention is thus not described in the above-mentioned DE 27 43 289. As far as the stirrer is concerned, the same is true of the built-in elements disclosed in U.S. Pat. No. 5,433,765 A.

In preferred embodiments of the refining apparatus claimed in the appended claims the at least one horizontally extending refining section is a horizontally extending flow duct provided with a fire resistant cover. The cover extends over at least a part of the horizontally extending flow duct, so that a surface of the glass melt is in contact with it over a substantial lengthwise portion of the horizontally extending flow duct. In this embodiment the cover is provided with at least one opening, in which a free surface of the glass melt is exposed for escape of gas bubbles when the glass melt is present in the horizontally extending flow duct.

In other embodiments or in addition at least one built-in element is provided in a flow duct in the at least one horizontally extending refining section. This built-in element is formed for at least partial immersion in the glass melt and may be arranged in an upper portion of the glass melt near its surface. It can extend parallel to or at a small angle to a principal flow direction of the glass melt pr vertically or only slightly inclined to a vertical direction. It may be rigidly or flexibly attached in the flow duct.

In preferred embodiments of the refining apparatus according to the invention the at least one built-in element comprises a plurality of parallel bars or rods arranged in the flow duct, which are connected with each other by strips. Alternatively the at least one built-in element is formed by a plurality of flow bodies arranged parallel to each other extending in a glass melt flow direction and the flow bodies have a predetermined cross-section. However it is important, as noted above, that these built-in elements should extend over a substantial longitudinal or lengthwise portion of the refining section or flow duct to provide the benefits of the invention.

### BRIEF DESCRIPTION OF THE SEVERAL VIEWS OF THE DRAWING

The objects, features and advantages of the invention will now be illustrated in more detail with the aid of the following description of the preferred embodiments, with reference to the accompanying figures in which:

FIG. 1A and FIG. 1B are a longitudinal cross-sectional view through and a top plan view, respectively, of a flow rate profile of a glass melt, which is improved according to the invention for gas bubbles removal;

FIG. 2 is a longitudinal cross-sectional view through a flow duct acting as refining section, which is provided with a cover over a substantial lengthwise portion of the refining section, which is in flow contact with the surface of the glass melt, and which has an opening for escape of gas bubbles;

FIGS. 3A and 3B are, respectively, a longitudinal cross-sectional view and a transverse cross-sectional view taken along the section line A-A in FIG. 3A of a flow duct with an exposed glass melt surface acting as refining section, which is provided with a built-in element for flow equalization in the form of a plurality of rods, which are arranged substantially parallel to the flow direction near the exposed glass melt or bath surface, wherein the rods are connected with each other by strips and the entire built-in element is attached to the bottom of the refining unit by outer rod elements;

FIGS. 4A and 4B are, respectively, a longitudinal cross-sectional view and a transverse cross-sectional view taken along the section line A-A in FIG. 4A of a flow duct acting as refining section, which is provided with a built-in element for flow equalization in the form of a plurality of plates, which are arranged extending parallel to the flow direction, partially immersed in the glass melt and attached to the cover of the refining unit; and

FIG. 5A and FIG. 5B are a longitudinal cross-sectional view through and a top plan view, respectively, of a flow rate profile of a glass melt in a flow duct in a refining apparatus according to the prior art, i.e. in an open channel flow.

### DESCRIPTION OF THE PREFERRED EMBODIMENTS

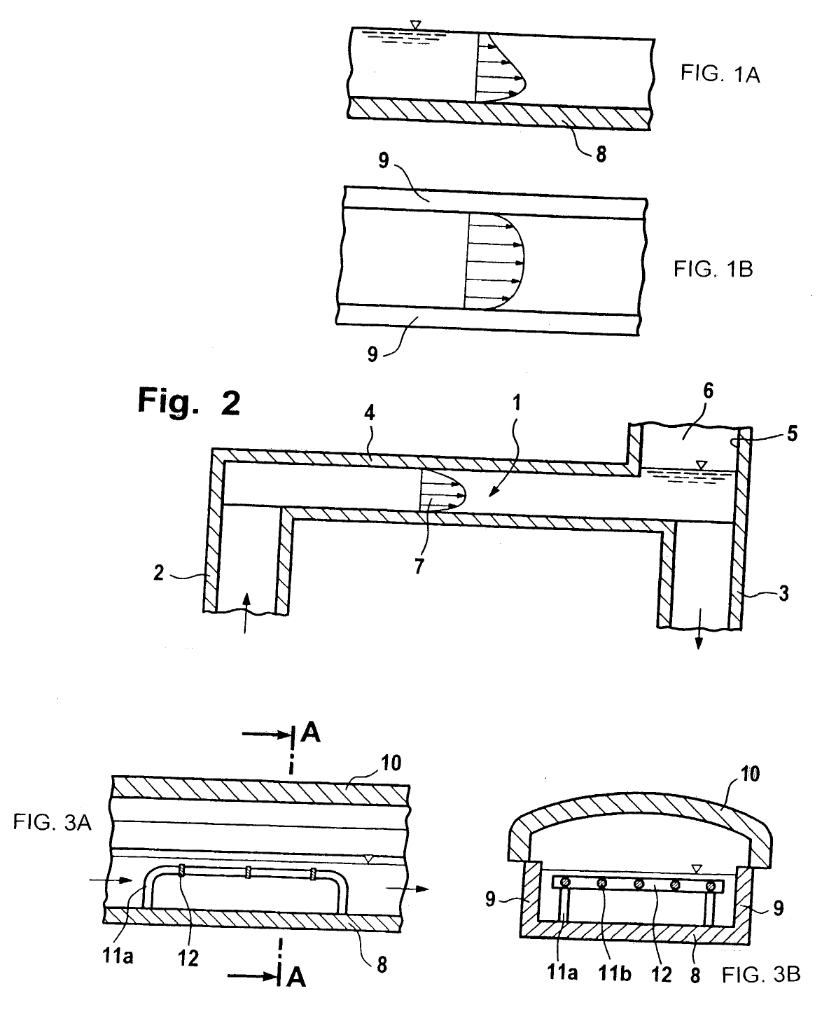

FIG. 1 shows a flow rate profile of the glass melt to be refined in a horizontally extending refining section of a refining unit according to the invention, which has improved features for refining the glass melt. This sort of refining apparatus for removing gas bubbles from a glass melt, in which the gas bubbles rise from the melt because of density differences is known in many different forms or embodiments. An example of this sort of refining apparatus is described in U.S. Pat. No. 1,598,308 for the Pike process. This latter apparatus is not described in more detail here.

In comparison to the flow rate profile in an open channel, as shown in FIG. 1A, the flow rate is increased over a substantially lengthwise portion of the refining section near the bottom of the refining channel and decreased near the upper surface of the glass melt. Because of that, the portion of the glass melt near the bottom, which is comparatively bubble free because of the rising of the bubbles, travels with comparatively greater speed to the outlet of the refining section (compared to the prior art situation shown in FIGS. 5A and 5B). Also, the portion of the glass melt, still not entirely bubble free in the upper layers, flows with comparatively reduced speed to the outlet, permitting more time for refining.

Also the flow rates are more uniform or vary less (in comparison to the prior art situation shown in FIGS. 5A and 5B) in the horizontal plane passing through the flow duct, i.e. transverse to the flow direction through the flow duct, as shown in FIG. 1B. This type of flow is improved for removal of gas bubbles from the glass melt in comparison to the flow in the prior art refining apparatus.

The flow rate profile given in FIGS. 1A and 1B is typical for embodiments of the claimed refining apparatus according to the invention, however it is not achieved exclusively by the features shown in the following FIGS. 2 to 4, either individually or in combination with each other.

FIG. 2 shows a horizontal flow duct 1 forming a refining section made from known fire resistant material (fire resistant stone, platinum, etc.) with a riser shaft 2 for admitting the glass melt to be refined in the direction of the arrow and a drop shaft 3 for guiding the refined glass melt from this refining section.

For changing the flow rate profile of an open channel flow the flow duct has a cover 4 of a suitable material, e.g. fire resistant stone, platinum, etc., extending along a substantial lengthwise portion of the refining channel. The cover is arranged over the flow channel, so that the upper surface of the glass melt comes into contact with the cover. The cover has at least one opening 5, at which the glass melt has an exposed surface. The opening is formed so that all gas bubbles rising to the cover can reach the exposed surface. A gas chamber 6 is located above the free surface. The gas bubbles escape into this gas chamber 6. From there the gas reaches the surrounding atmosphere outside of the unit.

Because the cover 4 is in direct contact with the glass melt, the glass melt flows slower in the contact zone, so that, as the flow rate profile 7 shows in comparison to the prior art flow rate profile shown in FIG. 5A, the flow properties are compensated or balanced. An additional advantage of this embodiment with a cover 4 in comparison to embodiments with an exposed glass bath surface is that the mass flow rate of the components evaporating from the glass melt is reduced by the cover.

In a further embodiment at least one built-in element is provided in a region of the glass melt close to or near the surface of the glass melt. This built-in element may change the flow rate profile so that flow rate profile shown in FIGS. 1A and 1B can be obtained. This at least one built-in element is made from a suitable material, such as platinum, molybdenum, fire resistant ceramic material.

Generally this further embodiment should be such that

the built-in element or elements influence the glass flow along a substantial lengthwise portion of the refining section,

the built-in element or elements are partially or completely immersed in the glass melt, and

substantially arranged in an upper surface region of the glass melt, and

preferably parallel or at a slight angle to the main flow direction.

The built-in element should:

preferably extend in a vertical direction or at a slight angle to the vertical direction,

the attachment in the refining unit can occur in any arbitrary suitable manner, i.e. to the bottom and/or the cover and/or to one or more side walls, and if necessary by connection of several built-in elements with each other, and

the built-in element is connected rigidly or flexibly, e.g. by chain links, with the refining unit.

The built-in element can also be a body, which floats in the glass melt and thus is partially immersed in the glass melt.

Further considerations for the built-in element are that the distances between the built-in element, the lateral walls and the bottom as well as between plural built-in elements are selected so that the desired change of the flow rate profile occurs.

The built-in element should have as small as possible a structural volume with the geometry or shape required for its function. Also it should be sufficiently thin. The available volume for the glass melt in the refining unit should be reduced as little as possible by the built-in element. It should not be much less than the available volume of the open channel without the built-in element.

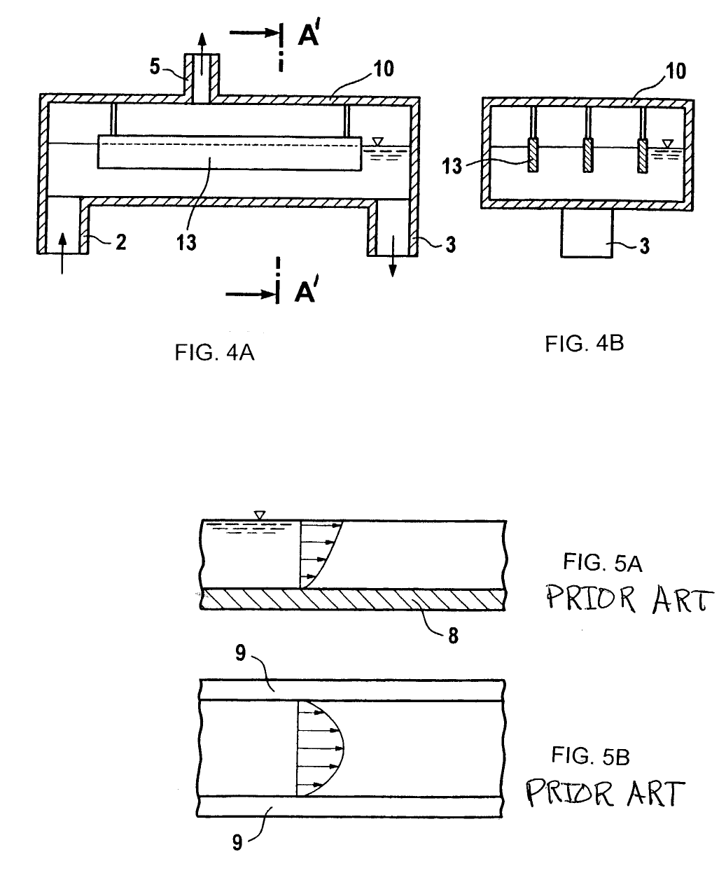

FIGS. 3A and 3B and 4A and 4B illustrate two typical embodiments of refining sections with built-in elements in the flow duct, and of course in a longitudinal cross-sectional view (left figure; 3A, 4A) and a transverse cross-sectional view (right figure; 3B, 4B).

FIGS. 3A and 3B show a refining unit with bottom 8, side walls 9 and cover or roof 10, in which several—here five—built-in elements 11a and 11b in the form of rods are arranged substantially parallel to the flow direction. Both outer built-in elements 11a are attached at their ends to the bottom 8. The other or inner built-in elements 11b are attached to each other and with the outer builtin elements 11a by means of laterally extending or transverse strips 12. The flow in the upper region of the glass melt is thus slowed by friction with the built-in elements 11a and 11b in this region near the surface. There the flow rate profile is compensated or balanced by a number of built-in elements, also by the width of the refining unit. Thus the original flow rate profile for the open channel flow of the prior art according to FIGS. 5A and 5B is changed into a flow rate profile of the invention according to FIGS. 1A and 1B.

FIGS. 4A and 4B show an additional possible embodiment of a refining unit according to the invention. In this embodiment here several—here three—small flow bodies 13 are arranged extending along the flow direction. These flow bodies 13 are suspended from the roof or cover 10 and are partially immersed in the glass melt, which slows the flow in the surface region of the glass melt. This is because the flow bodies 13 are provided as built-in elements in the flow region or zone near the surface of the glass melt.

Instead of the built-in elements provided in FIGS. 3A and 3B and FIGS. 4A and 4B the built-in elements according to the invention can have any arbitrary geometric form, particularly they can also have curved surfaces and surfaces with openings, such as slots or perforations.

Particularly the built-in element can be used in lower pressure refining units and in refining banks, but also in glass melt vessels and in refining vessels.

The term “substantial lengthwise portion” of the refining section or the like means a substantial part or portion of the refining section extending in the direction in which the glass melt flows through the refining section. The term “substantial lengthwise portion of the refining section” encompasses an embodiment comprising the entire refining section or another embodiment comprising a major portion of the refining section. A “major portion of the refining section” means more than one half of the refining section.

The disclosure in German Patent Application 102 25 280.7-45 of Jun. 7, 2002 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in an apparatus for refining a glass melt, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. An apparatus for refining a glass melt, said apparatus comprising a refining unit, wherein said refining unit includes at least one horizontally extending refining section for removal of rising gas bubbles from a glass melt flowing through said at least one horizontally extending refining section; wherein the at least one horizontally extending refining section is formed or structured so that a glass melt flow rate near a bottom of the glass melt is higher over a substantial lengthwise portion of the at least one horizontally extending refining section in comparison to a corresponding glass melt flow rate near said bottom in an open channel flow for equal throughput and/or so that a glass melt flow rate in the vicinity of a surface of the glass melt is lower in comparison to a corresponding glass melt flow rate in the vicinity of the surface of the glass melt in an open channel flow for equal throughput.

2. The apparatus as defined in claim 1, wherein said at least one horizontally extending refining section is formed so that glass melt flow rates distributed over a horizontal plane extending across said at least one horizontally extending refining section vary less than corresponding glass melt flow rates distributed over said horizontal plane in an open channel flow for the same throughput.

3. The apparatus as defined in claim 1, wherein said at least one horizontally extending refining section is a horizontally extending flow duct, and further comprising a cover (4) for said flow duct, said cover consisting of fire resistant material, and said cover extending over at least a part of said flow duct, so that a surface of the glass melt is in contact with said cover (4) over said substantial lengthwise portion, and wherein said cover is provided with at least one opening (5), in which a free surface of said glass melt is exposed for escape of said gas bubbles in said glass melt when said glass melt is present in the horizontally extending flow duct.

4. The apparatus as defined in claim 1, wherein said at least one horizontally extending refining section is a horizontally extending flow duct, and further comprising at least one built-in element (11a, 11b; 13) in said horizontally extending flow duct.

5. The apparatus as defined in claim 4, wherein said at least one built-in element (11a, 11b; 13) is formed for at least partial immersion in said glass melt when said glass melt is present in said horizontally extending flow duct.

6. The apparatus as defined in claim 4, wherein said at least one built-in element (11a, 11b; 13) is arranged in said horizontally extending flow duct so as to be in an upper portion of said glass melt near said surface of said glass melt when said glass melt is present in said horizontally extending flow duct.

7. The apparatus as defined in claim 4, wherein said at least one built-in element (11a, 11b; 13) extends in a direction parallel to or at a small angle to a principal flow direction of the glass melt through said flow duct.

8. The apparatus as defined in claim 5, wherein said at least one built-in element (11a, 11b; 13) extends vertically or only slightly inclined to a vertical direction.

9. The apparatus as defined in claim 5, wherein said at least one built-in element (11a, 11b; 13) is rigidly attached in said flow duct.

10. The apparatus as defined in claim 5, wherein said at least one built-in element (11a, 11b; 13) is attached in said flow duct so as to be flexible therein.

11. The apparatus as defined in claim 5, wherein said at least one built-in element comprises a plurality of parallel bars or rods (11a, 11b) arranged in said flow duct and strips (12) connecting said bars or rods.

12. The apparatus as defined in claim 5, wherein said at least one built-in element comprises a plurality of flow bodies (13) arranged parallel to each other and said flow bodies extend in a glass melt flow direction and have a predetermined cross-section.
